(19) United States
(12) Patent Application Publication
(10) Pub. No.: US 2002/0148780 A1
(43) Pub. Date: Oct. 17, 2002

(54) Method of enhancing biological activated sludge treatment of waste water, and a fuel product resulting therefrom

(76) Inventor: Eric B. Tiemeyer, Dallas, TX (US)

Correspondence Address: John E. Vandigriff, Suite 200, 190 N. Stemmons Frwy., Lewisville, TX, 75067, US

(21) Appl. No.: 09/834,202

(22) Filed: Apr. 13, 2001

(51) Int. Cl. C02F 3/00

(52) U.S. Cl. 210/609

(57) ABSTRACT

Cellulose-based catalytic media is introduced into the waste water treatment system with a very simple in-line eductor injection system to enhance biological treatment, to improve settability of the biomass, and to produce a biomass fuel. The cellulose-based catalytic media particles create a feeding site for the microbes that provides a rich food consisting of the organic load that has been absorbed and the naturally occurring glucose and protein. In addition, the cellulose-based catalytic media naturally contains a carbohydrate known as glycocalyx which functions as a flocculent by causing the smaller suspended solids in the final clarifier to “stick” together and form larger, heavier particles. The larger, heavier solid particles produce a biomass sludge that settles better and faster. The settled biosolids, which now contain fractions of the cellulose-based catalytic media, are then dewatered and dried to create a biomass fuel.

### FIELD OF THE INVENTION

The invention relates to a method of biologically treating waste water containing organic compounds, and more particularly to a method of treating waste water using a cellulose-based catalytic media that can provide a biomass fuel product to wastewater treatment facilities operating biological activated sludge systems (municipal and industrial) while enhancing the entire biological treatment system.

### BACKGROUND OF THE INVENTION

The below discussed prior patents define preparation of fibers for use in waste treatment and generally discuss the disadvantages of using absorbent materials in the treatment of waste material due to the dewatering required.

A method of separating kenaf into core and fiber has been described in U.S. Pat. No. 5,970,582. Disclosed is a method and apparatus for separating kenaf into fiber and core uses a modified stick machine conventionally used in the cotton industry for removing trash from unginned cotton. Lengths of kenaf are delivered onto the periphery of a saw cylinder so the toothed wheels snag the fiber and draw the kenaf across a grate. Core is detached from the fiber, passes through the grate and is delivered to a core outlet. Fiber on the toothed wheels are removed by a doffing wheel and delivered to a fiber outlet. Multiple saw cylinder/doffing wheel assemblies are provided.

A typical waste water sludge stabilization process is taught in U.S. Pat. Nos. 4,781,842 and 4,902,431 wherein a sewage sludge is stabilized and converted to fertilizer by mixing the sludge with an alkaline material which is sufficient to raise the pH to at least 12. The mixture is then allowed to dry for at least one day. The alkaline material is selected from cement, kiln dust, and lime dust, to achieve chemical stabilization. Bulking materials, such as slag fines, fly ash, gypsum, etc. may also be added. Such a process is primarily a drying process to eliminate offensive odors and pathogenic microorganisms. The process is not capable of generating a substantial amount of heat to destroy many of the contaminants found therein.

U.S. Pat. No. 6,027,652 describes one process for alleviating the environmental problems associated with the production of oil or chemical sorbent materials is to use a sorbent system based on natural fibers. Over the last several decades, a wide variety oftreated natural fibers have been used as sorbents of hazardous materials. These have included tree bark, peat, wood fiber, dealginate kelp, powdered lily, kenaf cores, puffed cereals, and a variety of other cellulosic materials. Each of these fiber types has disadvantages which have prevented them from becoming the material of choice for remediation of oil and chemical spills onland or in water. This patent states that the primary disadvantage of most of these fiber types is that they are naturally hydrophilic and, therefore, tend to sorb large quantities of water. Sorption of water increases the weight of these materials and can seriously decrease their ability to sorb the oil or hazardous chemical which these materials are intended to recover. It is possible to reduce or eliminate the tendency of some of these materials to sorb water by treatment with chemical additives to increase their hydrophobicity.

In U.S. Pat. No. 5,021,390, Hatton teaches a composition for sorbing liquids consisting of various fibrous plant materials treated with the waterproofing agent sodium methyl silicate. In U.S. Pat. No. 5,492,881, Diamond teaches a sorbent system using finely ground cellulose treated with a hydrophobic agent such as paraffin, other waxes, polyvinyl alcohol, hydroxyethyl cellulose or the like. These additives add to the manufacturing expense of the sorbent and may themselves be the source of further harm to the environment.

Another disadvantage, as disclosed in the prior art, of previously disclosed natural fiber based sorbents is that most are generally only capable of sorbing 5 to 10 times their mass in oil or other chemicals. Additionally, most of these natural fiber compositions have a tendency to sink as they become saturated with oil, water or other chemicals, making recovery of these materials and sorbed chemical from a body of water extremely difficult or impossible.

### SUMMARY OF THE INVENTION

In the invention a cellulose-based catalytic media is introduced into the wastewater treatment system with a very simple in-line eductor injection system at a rate that can range from 100 to 1000 mg/L. The cellulose-based catalytic media can be any organic or mostly organic solid that contains at least 5 percent cellulose material. Examples include, but are not limited to kenaf, jute, hemp, saw dust, tree bark, corn cobs, wheat straw, agricultural products and byproducts, and others. The catalytic media is typically ground to a granular or fine powder consistency to provide maximum surface area interaction. The point of injection may be anywhere in the waste water treatment system, depending on the particular beneficial result that is desired. The cellulose-based catalytic media, because of its highly absorptive characteristics, immediately “grabs” a portion of the organic load in the influent wastewater. The catalytic media particles naturally contain glucose and protein, a valuable source of energy for the microbes in the activated sludge system. As a result, the cellulose-based catalytic media particles are creating a site for the microbes that provides a rich food consisting of the organic load that has been absorbed and the naturally occurring glucose and protein. Furthermore, the catalytic media naturally contains and provides important nutrients (phosphorus, nitrogen, sulfur, calcium, potassium, and others) and a significant number of indigenous microorganisms to the biological system.

The net effect on the biological system is a much healthier and more viable microorganism population in the activated sludge system. Consequently, the system is less vulnerable to shock loads (swings in organic, toxic, and pH loading) and will recover from such events much faster. During normal loading, treatment efficiencies for pollutant removal will improve and thereby create an opportunity to increase loading to the biological system (provided the system can handle the additional hydraulic load). Or, improved treatment efficiencies may be used to minimize existing pollutant discharges in the effluent for environmental credit. Most importantly, expensive chemicals (pH adjustment and/or nutrients) that are currently added to the biological system may be reduced or eliminated.

The benefits to the wastewater treatment system are not limited to the activated sludge system (bioreactors). The cellulose catalytic media naturally contains a carbohydrate known as glycocalyx. The glycocalyx functions as a flocculent by causing the smaller suspended solids in the final clarifier to “stick” together and form larger, heavier particles. The larger, heavier solid particles produce a biomass sludge that settles better and faster. Wastewater treatment plants that are utilizing chemical coagulants and flocculants to enhance settling in the final clarifier may be able to reduce dosage or even eliminate these chemicals completely.

In addition, a portion of the carbohydrates in the kenaf core powder consists of hemi-cellulose. Some of the hemi-cellulose is not consumed by the microbes in the biological system and becomes an important substrate in the sludge that is wasted from the system. This waste activated sludge will dewater better and dry faster than sludge that does not contain the hemi-cellulose. The enhanced dewatering properties of the waste activated sludge may reduce or eliminate chemical treatment of the sludge, or it may eliminate dewatering operations altogether. Also, because the waste activated sludge contains the hemi-cellulose, it now has a higher heat energy content and can be dried and pelletized more economically. The dried pelletized sludge can be used as a biomass fuel in cement kilns or power plants.

### BRIEF DESCRIPTIONS OF THE DRAWINGS

FIG. 1 is a flow diagram of the process in which a cellulose-based catalytic media is used as a biological treatment enhancer and is introduced before a bio-reactor; and

FIG. 2 is a flow diagram of the process in which a cellulose-based catalytic media is used as a biological treatment enhancer, and introduced after a bio-reactor and before a clarifier.

### DESCRIPTION OF A PREFERRED EMBODIMENT

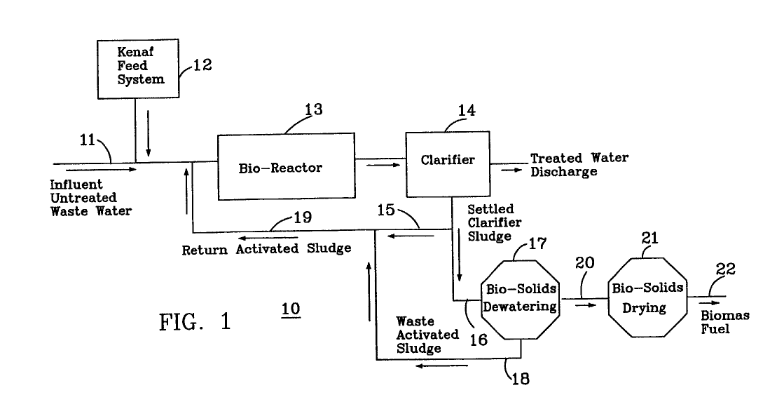

FIG. 1 is a flow diagram of the process where cellulose-based catalytic media 12 is introduced into the wastewater treatment system 11 with an in-line injection system at a rate of 100 to 1000 mg/liter. The cellulose-based catalytic media can be any organic or mostly organic solid that contains at least 5 percent cellulose material. Examples include, but are not limited to kenaf, jute, hemp, saw dust, tree bark, corn cobs, wheat straw, agricultural products and byproducts, and others. The catalytic media is ground to a granular or fine powder consistency to provide maximum surface area interaction. The point of injection may be anywhere in the waste water treatment system, depending on the particular beneficial result that is desired. Because of its highly absorptive characteristics, the cellulose-based catalytic media will immediately “grab” a portion of the organic load in the influent. The waste water and catalytic media combine and flow into a bio-reactor where microbes and other elements break down the waste in the influent. The sludge mass is carried through a clarifier 14. Waste activated sludge 16 flows to a bio-solids dewatering station while a part (19) of the activated sludge (10% to 50%) may be returned to the bio-reactor 13 for further processing. The sludge in the bio-solids dewatering station 17 is de-watered, with the water being returned (18) to the bio-reactor, and the dewatered solids going through a bio-solids drying process 21. The dried solids are then removed for use as a biomass fuel.

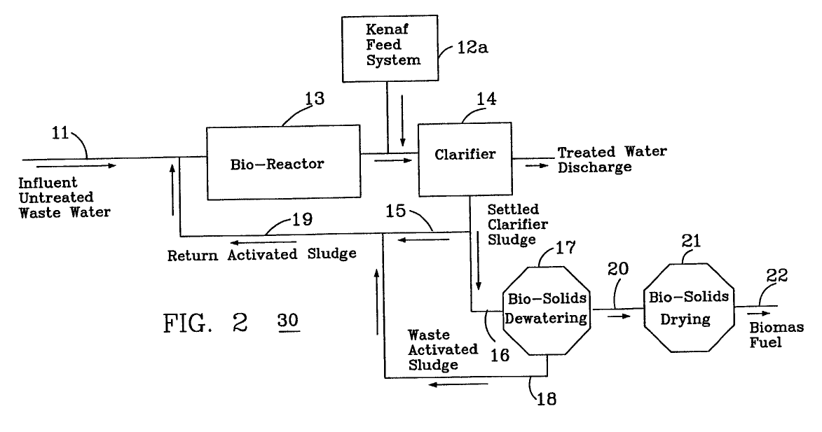

In FIG. 2, the cellulose-based catalytic media particles used in the process are introduced into the system after the bioreactor, and before the clarifier. In this process, the cellulose-based catalytic media particles are not entirely broken down as they would be in the bio-reactor, and provide more material for producing the biomass fuel. When the cellulose-based catalytic media particles are introduced after the bio-reactor, they are still mixed with material in the sludge.

The cellulose-based catalytic media particles used in the process naturally contain glucose and protein, a valuable source of energy for the microbes in the activated sludge system. As a result, the catalytic media particles are creating a site for the microbes that provides a rich food consisting of the organic load that has been absorbed and the naturally occurring glucose and protein. Furthermore, the cellulose-based catalytic media naturally contains, and provides to the biological system, important nutrients (phosphorus, nitrogen, sulfur, calcium, potassium, and others) along with a significant number of indigenous microorganisms. The net effect on the biological system is a much healthier and more viable microorganism population in the activated sludge system. Consequently, the system is less vulnerable to shock loads (swings in organic, toxic, or pH loading) and will recover from such events much faster. During normal loading, treatment efficiencies for pollutant removal will improve and thereby create an opportunity to increase loading to the system or minimize existing pollutant discharges for environmental credits. Most importantly, costly chemicals (pH adjustment and/or nutrients) that are currently added to the biological system may be reduced or eliminated.

The benefits to the wastewater treatment plant are not limited to the activated sludge system (bioreactors). The cellulose-based catalytic media naturally contains a carbohydrate known as glycocalyx. The glycocalyx functions as a flocculant by causing the smaller suspended solids in the final clarifier to “stick” together and form larger, heavier particles. The larger, heavier solid particles produce a biomass sludge that settles better and faster. Facilities that are utilizing coagulants and flocculants to enhance settling may be able to reduce dosage or even eliminate these chemicals completely.

In addition, the waste activated sludge (bio-solids or bio-sludge) that must be purged from the biological system dewaters better and has a much faster drying time. The enhanced dewatering and drying properties of the sludge may eliminate dewatering processes in some treatment plants. More importantly, because the sludge now contains some of the cellulose-based catalytic media, it can be dried and pelletized more economically, and it contains a higher heat energy value. The sludge can then be shipped to cement kilns or power plants as a biomass fuel.

Cement kilns release huge quantities of CO2, one of the most important Greenhouse Gases (GHG). CO2 emissions from the cement manufacturing industry are released by two different processes. First, limestone must be heated to approximately 2600 degrees F. to produce the cement product. This requires the combustion of a tremendous amount of fossil fuel (usually coal). Second, when the limestone is heated, it undergoes a process called calcination and releases large quantities of CO2. Because limestone must be heated and calcined to manufacture cement, the cement industry has very limited options in dealing with GHG (CO2) emissions and the reductions thereof. There is a major initiative underway in the cement industry to find a solution to this problem.

The biomass fuel produced from the dried and pelletized sludge can provide cement plants a fuel source with CO2 credits. This biomass fuel, because it is composed of kenaf powder, is renewable and sustainable. CO2 credits are created by replacing carbon-rich fossil fuel with biomass fuel that has sequestered carbon from the atmosphere during the catalytic media growing season.

Another benefit of using this biomass fuel in cement kilns is the ability of the cement kilns to utilize the inorganic solids (ash) that are part of the combusted biomass fuel. These inorganic solids become part of the cement manufacturing raw materials and actually provide increased production to the cement plants. Considering the CO2 credits and production increases, this fuel should bring a price comparable to high-quality coal. The cellulose-based catalytic media enhances biological activity in activated sludge wastewater treatment, improves settability of biological sludge in the final clarifier, and improves the dewatering and drying characteristics of the waste activated sludge.

The cellulose-based catalytic media offers a natural and cost effective alternative to expensive chemical treatment programs at biological activated sludge wastewater treatment plants. The catalytic media provides a benefit to all aspects of the biological treatment system. Expensive chemical treatment programs for nutrient addition, coagulant and flocculant addition, and dewatering can be significantly reduced or eliminated. Cellulose-based catalytic media is a natural and environmentally safe product that is not synthetically manufactured. It is completely biodegradable and does not introduce chemical residues into the environment. The dried and pelletized hemi-cellulose enhanced biosolids (waste activated sludge) are much easier to handle and transport, and they can be utilized as a fertilizer or biomass fuel. This creates a potential revenue generating product versus a waste that must be shipped to a landfill for disposal.

What is claimed:

1. A method of treating waste water comprising the step of:
introducing cellulose-based catalytic media into the waste water treatment system;
processing the influent waste water and cellulose-based catalytic media in a bio-reactor; and
dewatering the waste water and cellulose-based catalytic media mixture to produce a bio-solid material.

2. The method according to claim 1, wherein the cellulose-based catalytic media can be any organic or mostly organic solid that contains at least 5 percent cellulose material.

3. The method according to claim 1, wherein cellulose catalytic media is introduced into the waste water treatment system at a rate range 100 to 1000 mg/liter.

4. The method according to claim 1, wherein after the dewatering process the bio-solid material is dried to produce a biomass fuel.

5. The method according to claim 1, including a clarifier step prior to directing settled clarifier sludge to the bio-solid dewatering step.

6. A method of treating waste water comprising the step of:
introducing cellulose-based catalytic media into the waste water treatment system;
processing the waste water and cellulose-based catalytic media in a bio-reactor;
processing the waste water and cellulose-based catalytic media mixture in a clarifier; and
dewatering the waste water and cellulose-based catalytic media mixture to produce a bio-solid material.

7. The method according to claim 6, wherein the cellulose-based catalytic media can be any organic or mostly organic solid that contains at least 5 percent cellulose material.

8. The method according to claim 6, wherein cellulose-based catalytic media is introduced into the waste water treatment system at a rate range of 100 to 1000 mg/liter.

9. The method according to claim 6, wherein after the dewatering process the bio-solid material is dried to produce a biomass fuel.

10. A method of producing a biomass fuel, comprising the steps of:
mixing cellulose-based catalytic media with waste water, processing the waste water and cellulose-based catalytic media in a Clarifier; and
dewatering and drying the biomass solids resulting from the bio-reactor processed waste water and cellulose-based catalytic media.

11. The method according to claim 10, wherein the cellulose-based catalytic media can be any organic or mostly organic solid that contains at least 5 percent cellulose material.

12. The method according to claim 10, wherein cellulose-based catalytic media is introduced into the waste water treatment system at a rate range of 100 to 1000 mg/liter.

13. The method according to claim 10, wherein after the dewatering process the bio-solid material is dried to produce a biomass fuel.

14. The method according to claim 10, including the step of separating the solids from the water in the clarifier.

15. The method according to claim 6, including the step of separating the solids from the water in the clarifier.
